(19) United States
(12) Patent Application Publication
(10) Pub. No.: US 2004/0229110 A1
(43) Pub. Date: Nov. 18, 2004

(54) Low voltage auto-interruption device of car battery

(76) Inventor: Tsung-Jung Tsai, Taipei Hsien (TW)

Correspondence Address: Tsung-Jung Tsai, 235 Chung - Ho, Box 8-24, Taipei, TW

(21) Appl. No.: 10/634,673

(22) Filed: Aug. 6, 2003

(30) Foreign Application Priority Data
May 15, 2003 (TW) 092208856

(51) Int. Cl. H01M 10/42; H02J 7/00

(52) U.S. Cl. 429/61; 320/136

(57) ABSTRACT

A low voltage auto-interruption device of a car battery comprises a voltage detection and interruption device. The voltage detection and interruption device is installed between a power consuming device in a car, a battery for supplying power to the power consuming device; and a switch of the power consuming device. When a voltage of the battery is lower than a preset value, the voltage detection and interruption device interrupts a power of the power consuming device. The voltage detection and interruption device includes a high voltage comparator, a low voltage comparator and an interruption control circuit. The power consuming device is one selected from headlights, air cleaners fog lights, DVD drives, VCD drives, liquid crystal TVs, Audio devices, car used players, Kara OK, and amplifiers.

### FIELD OF THE INVENTION

The present invention relates to power devices, and particularly to a low voltage auto-interruption device of a car battery which comprises a voltage detection and interruption device. When a voltage of the battery is lower than a preset value than the voltage detection and interruption device interrupts a power of the power consuming device.

### BACKGROUND OF THE INVENTION

Currently, many power-consuming devices in cars are not interrupted, even the devices are not used. The power consuming device can be for example, headlights, air cleaners fog lights, DVD drivers, VCD drivers, liquid crystal TVs, Audio devices, car used players, Kara OK, and amplifiers etc. Thereby, they consume power continuously. If the car is not used for a long time, it is very possible that the power stored in the battery is used up so that as the driver can not actuate the engine of the car next time. This case especially occurs in headlights since headlights consume a larger amount power, if the driver forget to stop the power of the headlights, it is very possible that the power of the battery is used up in a short time period because the headlights consume power greatly.

### SUMMARY OF THE INVENTION

Accordingly, the primary object of the present invention is to provide a low voltage auto-interruption device of a car battery which comprises a voltage detection and interruption device. The voltage detection and interruption device is installed between a power consuming device in a car, a battery for supplying power to the power consuming device; and a switch of the power consuming device. When a voltage of the battery is lower than a preset value, the voltage detection and interruption device interrupts a power of the headlight. The voltage detection and interruption device includes a high voltage comparator, a low voltage comparator and an interruption control circuit. The power consuming device is one selected from headlights, air cleaners fog lights, DVD drivers, VCD drivers, liquid crystal TVs, Audio devices, car used players, Kara OK, and amplifiers.

The various objects and advantages of the present invention will be more readily understood from the following detailed description when read in conjunction with the appended drawing.

### BRIEF DESCRIPTION OF THE DRAWINGS

FIG. 1 shows the structure of the present invention.

FIG. 2 shows the circuit of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

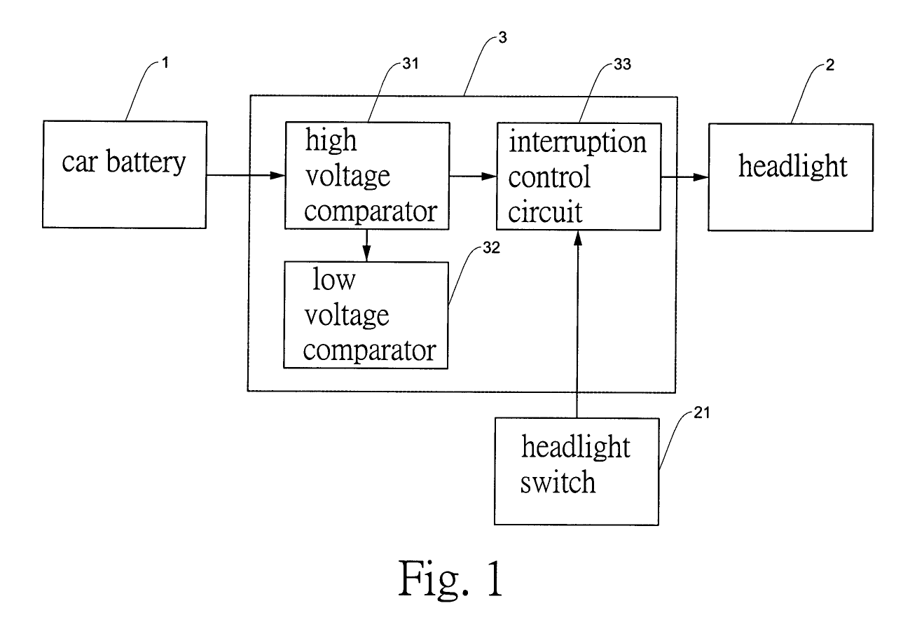

Referring to FIG. 1, the low voltage auto-interruption device of a car battery of the present invention is illustrated. In the present invention, a plurality of voltage detectors. In this embodiment, the present invention is used to a headlight of a car.

The headlight 2 has a power supply from a car battery 1. The headlight 2 is controlled by a headlight switch 21. In the present invention, a voltage detection and interruption device 3 is added to the circuits of the battery 1, headlight 2, and headlight switch 21.

The voltage detection and interruption device 3 is formed by a high voltage comparator 31, a low voltage comparator 32 and an interruption control circuit 33. The high voltage comparator 31 is connected between the battery 1, the low voltage comparator 32 and the interruption control circuit 33. The low voltage comparator 32 is connected to a battery 1 and the high voltage comparator 31. The interruption control circuit 33 is connected to the high voltage comparator 31, headlight 2 and the headlight switch 21.

The voltage detection and interruption device 3 is connected between the battery 1 and the headlight 2. The voltage detection and interruption device 3 can detect the potential of the battery 1. When the battery 1 supplies power, the high voltage comparator 31 and low voltage comparator 32 compare the voltage of the battery 1. If the voltage of the battery 1 is not lower than that voltage of the low voltage comparator 32, the voltage is normal. If the voltage of the battery 1 is lower than that of the low voltage comparator 32, then the interruption control circuit 33 will interrupt the front end power of the headlight 2. Thereby, if the power of a car is not interrupted when the driver leaves the car, the voltage of the battery 1 is lowered, but the headlight 2 can be interrupted automatically so that some power will be retained in the battery 1. Thus the engine of the car can be actuated next time.

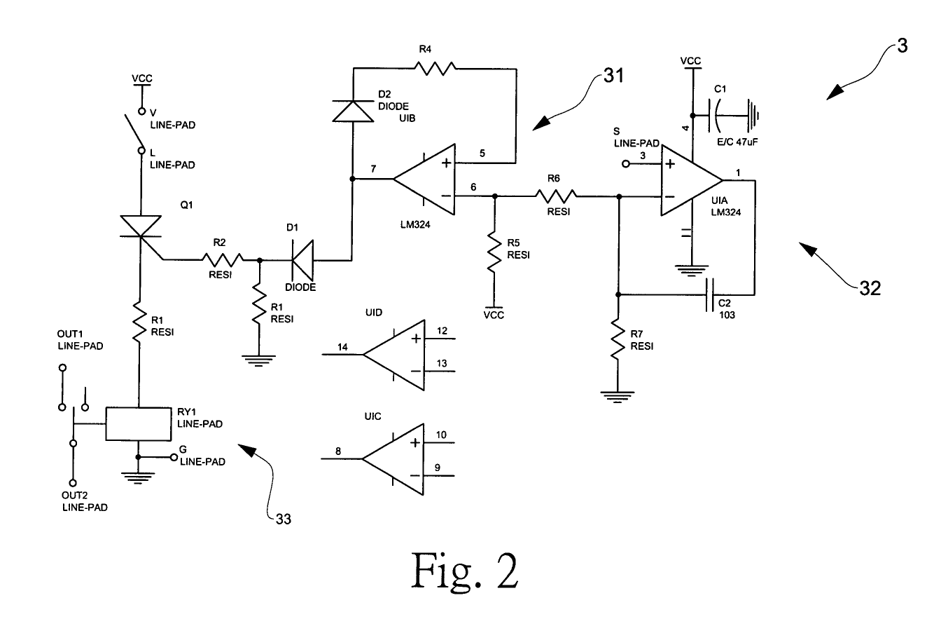

Referring to FIG. 2, a circuit of FIG. 1 is illustrated. In this circuit, it is shown that the interruption control circuit 33 can be realized by relays.

In above description, the headlight 2 of a car is used as an example, however, the present invention is not confined to the headlight 2. For example, the present invention can be used to air cleaners fog lights, DVD drives, VCD drives, liquid crystal TVs, Audio devices, car used players, Kara OK, amplifiers, etc. In these devices, the voltage detection and interruption device 3 of the present invention can be used so as to assure the battery or cells have sufficient power.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A low voltage auto-interruption device of a car battery comprising a voltage detection and interruption device; the voltage detection and interruption device being installed between a power consuming device in a car, a battery for supplying power to the power consuming device; and a switch of the power consuming device; when a voltage of the battery is lower than a preset value, the voltage detection and interruption device interrupting a power supply of the power consuming device.

2. The low voltage auto-interruption device of a car battery as claimed in claim 1, wherein the voltage detection and interruption device includes a high voltage comparator, a low voltage comparator and an interruption control circuit.

3. The low voltage auto-interruption device of a car battery as claimed in claim 1, wherein the power consuming device is a headlight of the car.

4. The low voltage auto-interruption device of a car battery as claimed in claim 1, wherein the power consuming device is one selected from air cleaners fog lights, DVD drives, VCD drives, liquid crystal TVs, Audio devices, car used players, Kara OK, and amplifiers.
